(19) United States
(12) Patent Application Publication
(10) Pub. No.: US 2013/0101830 A1
(43) Pub. Date: Apr. 25, 2013

(54) Metal Organic Complexes For Improved Smoothness And Uniformity Of Thin Films Deposited From Nanocolloids Via Electrophoresis

(71) Applicants: Kevin V. Hagedorn, Northville, MI (US); Bing Liu, Ann Arbor, MI (US)

(72) Inventors: Kevin V. Hagedorn, Northville, MI (US); Bing Liu, Ann Arbor, MI (US)

(21) Appl. No.: 13/660,033

(22) Filed: Oct. 25, 2012

Related U.S. Application Data
(60) Provisional application No. 61/550,979, filed on Oct. 25, 2011.

(51) Int. Cl. C25D 15/00; B32B 5/16; B82Y 30/00

(52) U.S. Cl. 428/323; 204/471; 204/490; 428/704; 428/457; 428/446; 977/773

(57) ABSTRACT

Disclosed is a process for electrophoretic deposition of colloidal suspensions of nanoparticles, especially from aprotic solvents, onto a variety of substrates. The process provides chemical additives that can be used to improve thin films deposited from colloidal suspensions by increasing the rate of deposition and the smoothness of the deposited film. In this process, a chemical additive is used to improve the properties of the deposited thin films. The chemical additive comprises a redox couple, an organometallic complex, a metallocene, a ferrocene, or a nickelocene. The colloidal suspension can be composed of semiconductor, metal or ceramic nanoparticles suspended in an aprotic polar solvent such as acetone, acetonitrile, or pyridine. The process also improves the properties of thin films deposited from protic solvents. The particles have at least one dimension ranging from 0.1 nanometers (nm) to 500 nm.

### RELATED APPLICATIONS

This application claims the benefit of U.S. provisional application Ser. No. 61/550,979 filed Oct. 25, 2011.

### STATEMENT REGARDING FEDERALLY SPONSORED RESEARCH

NONE.

### TECHNICAL FIELD

The present invention relates to chemical additives that improve the quality of thin films deposited via electrophoresis.

### BACKGROUND

The following non-patent references are cited throughput the specification using their associated number, they are hereby incorporated by reference.

1. (a) Besra, L.; Liu, M., A review on fundamentals and applications of electrophoretic deposition (EPD). Progress in Materials Science 2007, 52 (1), 1-61; (b) Plankenhorn, W. J. Electrophoretic Deposition of Ceramic Coatings. 1969; (c) Mizuguchi, J.; Sumi, K.; Muchi, T.; Soyama, S. Nonaqueous Suspension for Electrophoretic Deposition of Powders. 1983.

2. James, R. O.; Davis, J. A.; Leckie, J. O., Computer simulation of the conductometric and potentiometric titrations of the surface groups on ionizable latexes. Journal of Colloid and Interface Science 1978, 65 (2), 331-344.

3. Rehkopf, C. H.; Speigel, K. Cathode Ray Tube Screen Structure. 1973.

4. Preece, R. A.; Topham, W. G. Electrodeposition. 1968.

5. Biest, O. O. V. d.; Vandeperre, L. J., Electrophoretic Deposition of Materials. Annu. Rev. Mater. Sci. 1999, 29, 327.

6. (a) Kumanotani, J.; Chofu-Shi Composition for Electrophoretic Deposition. 1966; (b) Swanson, R. G. Electrophoretic Coating Process. 1969; (c) Dieter, J. A.; Strand, R. C. Electrophoretic Deposition of Styrene-Maleic Anhydride Copolymers. 1976; (d) Hesse, W.; Ritz, J.; Zimmermann, R. Binders Based on Co-Condensates of Epoxy Resins and Resols with Amines a Process for Their Preparation and for Electrophoretic Deposition, and an Electrophoresis Bath. 1982.

7. Zhitomirsky, I., Cathodic electrodeposition of ceramic and organoceramic materials. Fundamental aspects. Advances in Colloid and Interface Science 2002, 97 (1-3), 279-317.

8. Zarbov, M.; Brandon, D.; Gal-Or, L.; Cohen, N., EPD of Metallic Silver Particles: Problems and Solutions. Key Engineering Materials 2006, 314, 95.

Electrophoretic deposition (EPD) is a well-established technique for depositing thin films of oxides and ceramics from stable suspensions of nanoparticles in water, a protic solvent, but there is a growing interest to extend this technique to aprotic solvents. Electrophoretic deposition is a process by which a suspension of charged particles moves under the influence of an electric field (electrophoresis) and is deposited onto a conductive electrode. In principle, it should be possible to electrophoretically deposit a thin film from any stable suspension of particles. For oxide and ceramic thin films, a stable colloidal suspension is easily obtained in water because the adsorption and desorption of protons largely determines the surface charge (ζ-potential) of the particles in protic solvents.¹ Charging of surface groups on oxide particles is well-documented, and these surface groups are broadly classified as acid, alkaline, or amphoteric in nature². The pH value at which the concentration of negative and positive charges on the particle surface are equal is termed the point of zero charge (pzt), and it depends on the nature of the surface groups of the oxide particles. By adjusting the pH, the ζ-potential of these oxide particles can be carefully tuned to ideal values for electrophoretic deposition. For many other types of particles, such as dye aggregates, phosphates³, and polymer resins⁴, the addition of dispersants and ionic additives, such as sodium chloride, aluminum alkoxide, or trichloroethylene, can control the ζ-potential by binding to the surface of the particle⁵. Ionic polymer binders often bind the particles and improve the quality of the adhered film⁶. Several reviews have been written discussing the effect additives and binders have on ζ-potential⁷. The commonality between using pH and ionic additives to control ζ-potential is that they are both done in water. In most critical reviews of electrophoretic deposition, references to organic solvents are generally to protic solvents such as methanol and ethanol, which, like water, support acid-base chemistry and dissolve a small amount of ions, but they have the added benefit of suppressing the formation of bubbles by avoiding water splitting^{1a, 2, 5}.

By contrast, in aprotic solvents, such as acetone, acetonitrile, or pyridine, dispersants and ionic additives are only sparingly soluble, and acid-base chemistry is not supported. It has been observed that EPD of colloids suspended in acetone is possible for some particles, such as In and MnO, but not for other types of nanoparticles such as Pt, Au, and Ag and the reason for this remains unclear. For other aprotic solvents, such as acetonitrile and pyridine, which have dipole moments and viscosities which are similar to acetone, EPD appears to be impossible. Development of EPD in these aprotic solvents will require completely new approaches to modify the ζ-potential of suspended particles and to promote deposition of charged particles onto a substrate.

In the last decade, synthetic preparation of nanometer-sized particles has developed rapidly due to the interest in the unique size-dependent properties of these particles, but these particles tend to be unstable in water, and EPD in aprotic solvents is difficult. Virtually all semiconductors and metals oxidize in air or protic solvents, and nanoparticles of these materials oxidize especially rapidly because of their high surface area. In fact, for nanoparticles prepared by chemical reduction of metal salts, which is the most common method for producing nanoparticles, oxidation is unavoidable. Though new techniques for preparing nanoparticles, such as laser ablation in liquid, are providing alternative methods for preparing nanoparticles in an inert environment, electrophoretic deposition of these metal and semiconductor particles has proven difficult. It has been observed when one attempts to electrophoretically deposit gold and silver nanoparticles from acetone, they agglomerate faster than they deposit, leading to a weakly-adherent film and a significant amount of agglomerated material that does not deposit⁸. One proposed explanation for this agglomeration behavior is that the colloidal suspension is unstable in the vicinity of the electrode. Near the surface of the electrode, the particle and ion concentrations are higher than in the bulk due to the migration of particles in the electric field, and also because ions are generated at the surface of the electrode in electrochemical reactions. A high ion concentration reduces the electrostatic repulsion between particles and causes the particles to flocculate^{1a}. Another explanation involves the failure of particles to deposit. Particles measuring approximately one micron or smaller will stay suspended in solution for long periods of time due to Brownian motion, and theoretical studies of EPD have shown that even near the surface of the electrode, Brownian motion continues because the inner Helmholtz plane prevents the particles from directly contacting the surface^{1a}. These particles near the surface do not deposit because they are never in electrical contact with the substrate. Both of these problems likely contribute to the observed failure of gold nanoparticles to deposit in aprotic solvents. In order to circumvent this problem, new additives need to be developed that are soluble in aprotic solvents, that do not increase the ionic conductivity of the solution, and that can be used to either prevent agglomeration of the particles or to enhance deposition rate.

### SUMMARY OF THE INVENTION

The present invention provides chemical additives that can be used to improve thin films deposited from colloidal suspensions by increasing the rate of deposition and the smoothness of the deposited film.

In this invention, a chemical additive is used to improve the properties of thin films deposited from a colloidal suspension of nanoparticles. In some embodiments, the chemical additive is either a redox couple, a metal organic complex, a metallocene, a ferrocene, or a nickelocene. The colloidal suspension can be composed of semiconductor, metal or ceramic nanoparticles suspended in an aprotic polar solvent such as acetone, acetonitrile, or pyridine. The particles have at least one dimension ranging from 0.1 nanometers (nm) to 500 nm.

### BRIEF DESCRIPTION OF THE DRAWINGS

FIG. 1. Scanning electron micrographs of gold nanoparticle thin films on a molybdenum substrate prepared using electrophoretic deposition of (a) a 1 ppm gold nanoparticle colloid. (b) a 1 ppm gold nanoparticle colloid in the presence of 26 μM ferrocene. Scale bar: 10 μm.

FIG. 2. Energy-dispersive X-Ray spectrum of a gold nanoparticle thin film on a polished silicon substrate prepared using electrophoretic deposition of a 10 ppm gold nanoparticle colloid in the presence of 26 μM ferrocene.

FIG. 3. Scanning electron micrographs of gold nanoparticle thin films on a polished silicon substrate prepared using electrophoretic deposition of a 10 ppm gold nanoparticle colloid in the presence of 26 μM ferrocene. Scale bar: 1 μm.

### DETAILED DESCRIPTION

In the present invention the following terms are defined as followed unless otherwise indicated.

“redox couple” refers to a pair of oxidizing and reducing agents which can be interconverted at the electrodes in an electrophoretic deposition process. The redox couples may be generated once a potential is applied to the solution. For example, in the case of ferrocene, the neutral compound can be added to solution. At the anode, the ferrocene is oxidized and the presence of the oxidized and neutral form in solution constitutes a redox couple.

“Nanoparticles” refers to particles having a size ranging from about 0.1 nm to 0.5 micrometers (μm) in at least one dimension.

“Surface charge” refers the total charge on a nanoparticle. The potential at the surface of sheer is termed ζ-potential and is related to surface charge. Surface charge and ζ-potential are dissimilar in that ζ-potential also includes ions bound to the surface, such that a particle with a negative surface charge could have a positive ζ-potential if a high concentration of positive ions were bound to the surface. However, these terms can often be used interchangeably.

“Colloidal suspension” refers to a liquid solvent containing system wherein surface-charged particles are microscopically suspended due to Brownian motion and electrostatic repulsion between the particles.

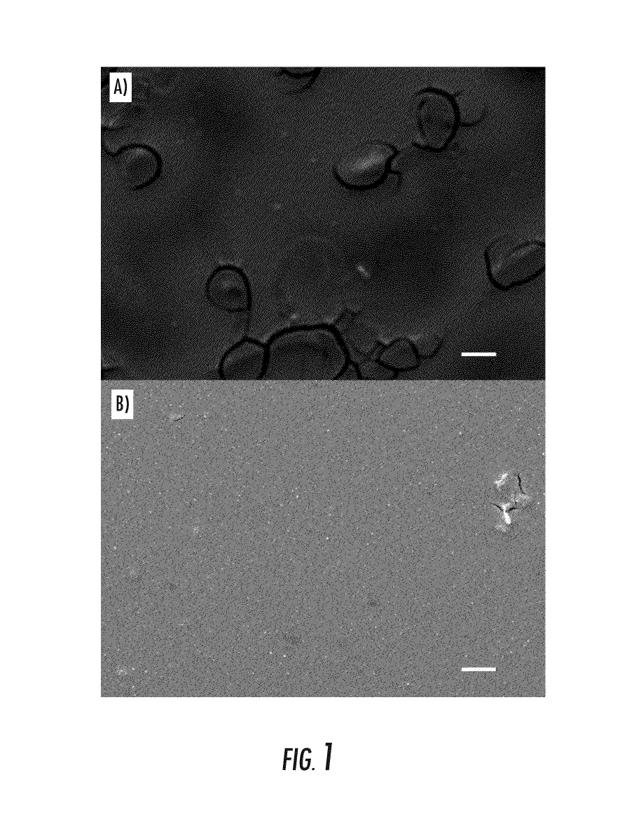

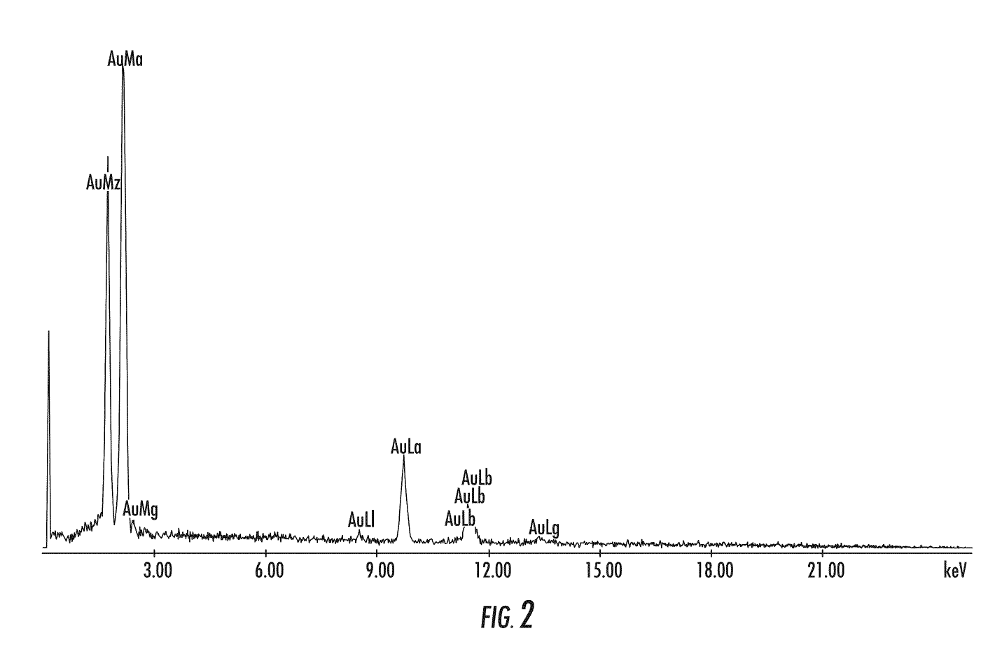

In certain embodiments, the chemical additive added to the suspension is a redox couple metallocene such as ferrocene or nickelocene, which enhances the rate of deposition and smoothness of the deposited thin film. The redox couple chemical additive can also be an organometallic complex. FIG. 1 highlights the differences between films deposited with and without ferrocene, under otherwise identical EPD conditions in an aprotic solvent. Without ferrocene, deposition of the particles tended to create patches of gold particles on the millimeter scale, in contrast, with ferrocene the film was entirely uniform and smooth. In addition, with ferrocene the deposition time was shorter. In one experiment, a 1 ppm gold nanoparticle suspension in acetone, an aprotic solvent, was deposited using electrophoretic deposition in a two-electrode cell composed of two molybdenum electrodes in the presence and absence of 23 μmol of ferrocene, a redox couple. An electric field of 1100V cm⁻¹ was applied between the electrodes and the nanoparticle suspension deposited in 1:50 minutes when ferrocene was present, but took 8 minutes to be deposited when ferrocene was absent. FIG. 1a shows a scanning electron micrograph of the film that was deposited in the absence of the ferrocene and FIG. 1b shows a scanning electron micrograph of the film deposited in the presence of the ferrocene. FIG. 1a, without ferrocene, shows the surface is very rough with sites of agglomeration forming peaks on the surface. FIG. 1b, with ferrocene, shows a very different morphology. The surface is uniform and smooth with no agglomerations or peaks. This despite the fact that the EPD is being conducted in an aprotic solvent, which has not previously been possible as shown in FIG. 1a. The ferrocene is not deposited with the gold nanoparticles because both its neutral and charged forms are stable in the solvent. This has been confirmed with elemental analysis, as energy-dispersive X-ray spectroscopy (EDX) shows no detectable amount of iron in the deposited film, as shown in FIG. 2. Previously investigated salts and organic binders alter electrophoretically deposited films either by acting as a glue, which changes the solution viscosity, or by binding to the surface of the particles and both of these actions change the zeta-potential of the particles. The ferrocene acts by a different mechanism as evidenced by the insensitivity of the zeta-potential of the particles to the amount of ferrocene added to a colloidal suspension of the particles, which was found to be 45±5 mV over a range of concentrations of ferrocene of from 10 μmol to 50 mmol in acetone. Similarly, in ethanol and methanol the zeta-potential was found to be 39±5 mV over a range of concentrations of ferrocene of from 10 μmol to 50 mmol.

Making a uniform film in accordance with the present invention could be accomplished using redox couples other than ferrocene. The role of the redox couple is to reduce electroconvection and to allow for a fast and even deposition of the particles onto the surface, even in aprotic solvents. Any fast redox couple that's soluble in polar solvents and stable with a large applied potential could be used. Metallocenes in general and ferrocene in particular fulfill these criteria well but other organometallic complexes or metallocene redox couples may also be used. Preferably, the redox couple is present in the colloidal suspension at a level of from 10 μmol to 50 mmol.

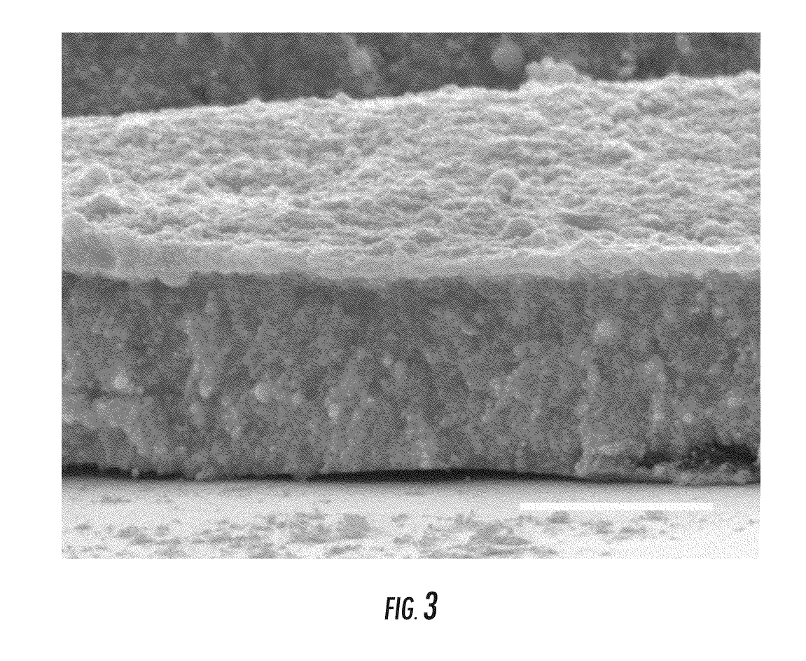

By way of example, a suitable precursor solution was prepared and deposited as follows. In this section, all chemicals were used as received. Gold (Au) nanoparticles were prepared by laser ablation of a Au target (SCI Engineered Materials) in acetone, an aprotic solvent, (Alfa Aesar, Spectrophotometric grade, 99.5% purity). An IMRA America D-10K fiber laser system was used to produce the particles. The laser output was tuned to 4W and a repetition rate of 500 kHz, 2 μS pulse repetition, was used. These settings yielded an energy-per-pulse of 6 μJ. A Scanlab hurrySCAN II system was used to scan the beam across the Au target surface. After about 40 minutes, the solution took on a deep red color with an absorbance peak at 518 nm indicating formation of Au nanoparticles. The maximum absorbance was approximately 1, which roughly corresponds to a particle concentration of 50 ppm with particle sizes of 12 nm±4. Then 20 mL of this solution was taken and mixed with 20 mL of 53 μmol ferrocene in acetone. Electrophoretic deposition was accomplished in a two-electrode cell with flat sheets of metal electrodes comprising molybdenum, steel, or titanium that were approximately 1 cm². A potential difference of 1.1 kV was applied between the two electrodes, which were separated by a distance of 1 cm. After the metal sheet substrate was removed from the solvent, a film of gold deposition was visible on the metal sheet. Scanning electron micrographs of a cross-section of the film on the substrate revealed that the thickness of the deposited film was approximately 0.5 microns, as shown in FIG. 3. Metal sheets of Mo, Fe and Ag were also used as the deposition surface with identical results. To demonstrate that this technique could be used to deposit thin films on highly resistive materials, intrinsic Si with a resistivity of >500 Ω/cm (Czochralski growth, ITME) was also tried as a substrate surface and a thin film of gold deposited on the surface which was similar to the films observed on metal substrates. As noted above, the colloidal suspensions of the present invention can comprise nanoparticles of a metal, a ceramic, or a semiconductor.

If desired the EPD can be conducted in an oxygen free environment or under an inert gas environment such as can be done in a glove box system as know to one of ordinary skill in the art. This can be particularly useful when the deposited film is sensitive to oxygen.

In one embodiment the present invention includes a colloidal suspension for electrophoretic deposition comprising: a colloidal suspension of particles in a solvent containing a redox couple, the redox couple increasing the smoothness and uniformity of a film formed by electrophoretic deposition of the particles onto a substrate compared to deposition of the particles in the absence of the redox couple. In an embodiment the colloidal suspension solvent is acetone, methanol, ethanol, acetonitrile, or pyridine. In an embodiment the redox couple is an organometallic complex. In an embodiment the redox couple is a metallocene. In an embodiment the redox couple is ferrocene or nickelocene. In an embodiment the colloidal suspension is composed of nanoparticles with sizes which range from 0.1 nanometers (nm) to 500 nanometers. In an embodiment the colloidal suspension is composed of nanoparticles with sizes which range from 1 nm to 100 nm. In an embodiment the colloidal suspension is composed of metal, ceramic, or semiconductor nanoparticles. In an embodiment the colloidal suspension is prepared in an oxygen free environment. In an embodiment, the colloidal suspension is prepared in an oxygen free environment in a glove box. In an embodiment the substrate is any conductive material, or any material which can be made conductive by applying a voltage of 1 to 5000V. In an embodiment the redox couple is present in an amount of from 10 μmol to 50 mmol.

In another embodiment, the present invention includes a thin film of particles on an electrically conductive or semiconductive substrate wherein the thin film is formed by electrophoretic deposition of the particles from a colloidal suspension in an aprotic solvent. In an embodiment the solvent is acetone, acetonitrile, or pyridine. In an embodiment the colloidal suspension is composed of nanoparticles with sizes which range from 0.1 nm to 500 nm. In an embodiment the colloidal suspension is composed of metal, ceramic, or semiconductor nanoparticles. In an embodiment the colloidal suspension is prepared in an oxygen free environment. In an embodiment the substrate is a material which can be made conductive by applying a voltage of 1 to 5000V. In an embodiment the colloidal suspension comprises a redox couple.

In another embodiment the present invention includes a method for the electrophoretic deposition of particles from a colloidal suspension onto a substrate by the improvement comprising: adding to the colloidal suspension a redox couple. In an embodiment the redox couple is an organometallic complex. In an embodiment the redox couple is a metallocene.

What we claim is:

1) A colloidal suspension for electrophoretic deposition comprising:
a colloidal suspension of particles in a solvent containing a redox couple, said redox couple increasing the smoothness and uniformity of a film formed by electrophoretic deposition of the particles onto a substrate compared to deposition of the particles in the absence of said redox couple.

2) The colloidal suspension of claim 1, where said solvent is acetone, methanol, ethanol, acetonitrile, or pyridine.

3) The colloidal suspension of claim 1, where said redox couple is an organometallic complex.

4) The colloidal suspension of claim 1, where said redox couple is a metallocene.

5) The colloidal suspension of claim 1, where said redox couple is ferrocene or nickelocene.

6) The colloidal suspension of claim 1, where said colloidal suspension is composed of nanoparticles with sizes which range from 0.1 nanometers (nm) to 500 nanometers.

7) The colloidal suspension of claim 1, where said colloidal suspension is composed of nanoparticles with sizes which range from 1 nm to 100 nm.

8) The colloidal suspension of claim 1, where said colloidal suspension is composed of metal, ceramic, or semiconductor nanoparticles.

9) The colloidal suspension of claim 1, where said colloidal suspension is prepared in an oxygen free environment.

10) The colloidal suspension of claim 9, wherein said colloidal suspension is prepared in an oxygen free environment in a glove box.

11) The colloidal suspension of claim 1, where the substrate is any conductive material, or any material which can be made conductive by applying a voltage of 1 to 5000V.

12) The colloidal suspension of claim 1, wherein the redox couple is present in an amount of from 10 μmol to 50 mmol.

13) A thin film of particles on an electrically conductive or semiconductive substrate wherein said thin film is formed by electrophoretic deposition of said particles from a colloidal suspension in an aprotic solvent.

14) The thin film of claim 13, wherein said solvent is acetone, acetonitrile, or pyridine.

15) The thin film of claim 13, wherein said colloidal suspension is composed of nanoparticles with sizes which range from 0.1 nm to 500 nm.

16) The thin film of claim 13, wherein said colloidal suspension is composed of metal, ceramic, or semiconductor nanoparticles.

17) The thin film of claim 13, wherein said colloidal suspension is prepared in an oxygen free environment.

18) The thin film of claim 13, where said substrate is a material which can be made conductive by applying a voltage of 1 to 5000V.

19) The thin film of claim 13, wherein said colloidal suspension comprises a redox couple.

20) In a method for the electrophoretic deposition of particles from a colloidal suspension onto a substrate the improvement comprising:
adding to said colloidal suspension a redox couple.

21) The method recited in claim 20, wherein the redox couple is an organometallic complex.

22) The method recited in claim 20, wherein the redox couple is a metallocene.
